(19) United States
(12) Patent Application Publication
(10) Pub. No.: US 2015/0378200 A1
(43) Pub. Date: Dec. 31, 2015

(54) LIQUID CRYSTAL DISPLAY DEVICE

(71) Applicant: InnoLux Corporation, Miao-Li County (TW)

(72) Inventor: Tzu-Chin SU, Miao-Li County (TW)

(21) Appl. No.: 14/717,154

(22) Filed: May 20, 2015

(30) Foreign Application Priority Data
Jun. 26, 2014 (TW) 103122042

(51) Int. Cl. G02F 1/13363; G02F 1/1335; G02F 1/1337; G02F 1/1368

(52) U.S. Cl. CPC G02F 1/13363; G02F 1/1368; G02F 1/133528; G02F 1/1337; G02F 1/133514

(57) ABSTRACT

A liquid crystal display device is disclosed, which comprises: a first polarizer; a second polarizer corresponding to the first polarizer; a liquid crystal panel disposed between the first polarizer and the second polarizer, the liquid crystal panel comprises a first liquid crystal layer having a first alignment direction; and a compensation member disposed between the first polarizer and the liquid crystal panel or between the second polarizer and the liquid crystal panel, the compensation member is attached on the liquid crystal panel, and the compensation member comprises a second liquid crystal layer having a second alignment direction; wherein the first and second alignment directions are substantially the same and the dielectric anisotropies of the first and second liquid crystals are the opposite.

### CROSS REFERENCE TO RELATED APPLICATION

This application claims the benefits of the Taiwan Patent Application Serial Number 103122042, filed on Jun. 26, 2014, the subject matter of which is incorporated herein by reference.

### BACKGROUND OF THE INVENTION

1. Field of the Invention

The present invention relates to a liquid crystal display device and, more particularly, to a liquid crystal display device in which the visual angle asymmetry and light leakage caused by the pre-tilt angle of the liquid crystal thereof may be improved.

2. Description of Related Art

In recent years, liquid crystal display, which is a planer and thin display device, has replaced the traditional cathode ray tube display due to its advantages of thin shape, light weight, and low power consumption. As a result, liquid crystal display has now become one of the most popular display devices. Liquid crystal display is widely applied in various devices ranging from small portable terminal devices to large televisions. However, the common flaw of liquid crystal display is its narrow visual angle. In order to solve this problem, wide visual angle display panels have been manufactured, such as Multi-domain Vertical Alignment (MVA) liquid crystal display device, In-Plan Switch (IPS) liquid crystal display, and Fringe Field Switching (FFS) liquid crystal display.

In particular, the principle of the IPS and FFS technologies is that: A pixel electrode and a public electrode constitute a planer electric field. This allows liquid crystal molecules to rotate horizontally in a plane parallel to the substrate to change the level of light transmittance. Since the horizontal rotation of liquid crystal molecules is maintained by the horizontal electric field, the visual angle of the IPS/FFS panel is relatively wide. The performance of color shift and saturation under such wide visual angle is quite excellent.

In general, the method for liquid crystal alignment of IPS/FFS is that: The top and bottom substrates are coated with polyimide alignment films (PI). A rubbing process by a cloth is performed to make the surface molecules of PI to arrange in a predetermined alignment orientation. This causes liquid crystal to possess an anchoring force in a single direction. However, after alignment, the dangling bonds or side chains of the surface molecules of PI will appear. Therefore, instead of having the orientation of the liquid crystal to be completely horizontal, a small pre-tilt angle (about 2 degrees) will exist. This pre-tilt angle will cause visual angle asymmetry and serious visual angle light leakage in the dark state, low contrast in visual angle, and other flaws of liquid crystal display. In order to reduce the pre-tilt angle of the liquid crystal, the current solutions are usually to change the alignment film materials or to perform alignment by photo-alignment. However, these solutions still cannot address the above problems effectively. Therefore, there is a need now to develop a liquid crystal display device with improved visual angle asymmetry and light leakage.

### SUMMARY OF THE INVENTION

The object of the present invention is to provide a liquid crystal display device, wherein the visual angle asymmetry and light leakage of the liquid crystal display device are improved.

To achieve the above object, the liquid crystal display device of the present invention includes: a first polarizer; a second polarizer corresponding to the first polarizer; a liquid crystal panel disposed between the first polarizer and the second polarizer, wherein the liquid crystal panel comprises a first liquid crystal layer having a first alignment direction; and a compensation member disposed between the first polarizer and the liquid crystal panel, or between the second polarizer and the liquid crystal panel, wherein the compensation member is attached on the liquid crystal panel, and the compensation member comprises a second liquid crystal layer having a second alignment direction; wherein the first alignment direction is substantially the same with the second aligning direction, and the dielectric anisotropies of the first and second liquid crystals are the opposite to each other.

In the liquid crystal display device of the present invention, the visual angle asymmetry and the light leakage caused by the pre-tilt angle of the first liquid crystal layer (i.e. the inclined angle formed between the first polarizer and the long axis of the liquid crystal molecules in the first liquid crystal layer) have been significantly improved through applying the compensation member. The complementary types of the liquid crystals in the compensation member and the first liquid crystal layer have been used. The thickness, the pre-tilt angle of the second liquid crystal layer (i.e. the inclined angle formed between the first polarizer and the short axis of the liquid crystal molecules in the second liquid crystal layer), and the disposed position of the compensation member have been selectively adjusted. The resulting liquid crystal display device of the present invention has visual angles that are wider and more symmetrical with lesser light leakage.

### BRIEF DESCRIPTION OF THE DRAWINGS

FIG. 1A is a schematic diagram of the liquid crystal display device of a preferred embodiment of the present invention;

FIG. 1B is a schematic diagram of a plurality of the first liquid crystal in the liquid crystal layer of the liquid crystal display device in FIG. 1A;

FIG. 1C is a schematic diagram of a plurality of the second liquid crystal in the compensation layer of the liquid crystal display device in FIG. 1A;

FIGS. 2A-2C are the test results of the light leakage in the dark state of the liquid crystal display device in FIG. 1A;

FIG. 3 is a schematic diagram of a liquid crystal display device another preferred embodiment of the present invention;

FIGS. 4A-4C are the test results of the light leakage in the dark state of the liquid crystal display device in FIG. 3;

FIG. 5 is a schematic diagram of a liquid crystal display device of another preferred embodiment of the present invention;

FIGS. 6A-6C are the test results of the light leakage in the dark state of the liquid crystal display device in FIG. 5;

FIG. 7 is a schematic diagram of the light leakage in the dark state affected by the pre-tilt angle (θ2) and the thickness (df) of the second liquid crystal of the liquid crystal display device in FIG. 5;

FIG. 8 is a schematic diagram of a liquid crystal display device of another preferred embodiment of the present invention

### DETAILED DESCRIPTION OF THE PREFERRED EMBODIMENT

Hereinafter, exemplary embodiments of the present invention will be described in detail. However, the present invention is not limited to the embodiments disclosed below, but can be implemented in various forms. The following embodiments are described in order to enable those skilled in the art to practice the present invention and to appreciate that various modifications, additions, and substitutions are possible.

### Example 1

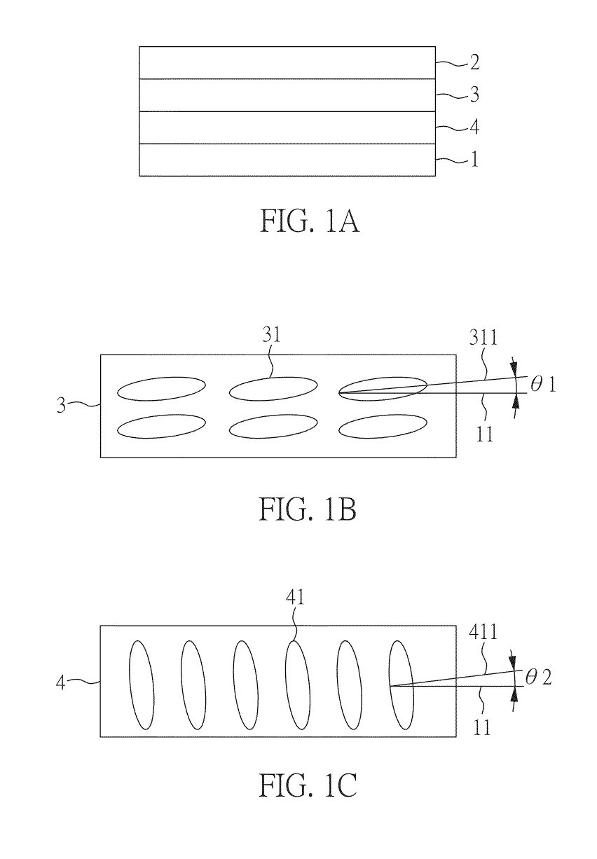

FIG. 1A is a schematic diagram of a liquid crystal display device of a preferred embodiment of the present invention. The liquid crystal display device includes: a first polarizer 1; a second polarizer 2 corresponding to the first polarizer 1; a liquid crystal panel disposed between the first polarizer 1 and the second polarizer 2, the liquid crystal panel comprising a first liquid crystal layer 3 having a first aligning direction; and a compensation member disposed between the first polarizer 1 and the second polarizer 2. The compensation member comprises a second liquid crystal layer 4, and the compensation member is on the liquid crystal panel. In the present example, the compensation member is disposed between the first polarizer 1 and the first liquid crystal layer 3 and is attached on the liquid crystal panel. However, the compensation member may also be disposed between the second polarizer 2 and the first liquid crystal layer 3.

Referring to FIGS. 1B and 1C, they are the schematic diagrams of a plurality of liquid crystal molecules 31 in the first liquid crystal layer 3 and a plurality of liquid crystal molecules 41 in the second liquid crystal layer 4 of the compensation member, respectively. The first liquid crystal layer 3 has a first alignment direction and the second liquid crystal layer 4 of the compensation member has a second alignment direction, wherein the first alignment direction is approximately the same with the second aligning direction with a difference of ±0.2 degrees. The first liquid crystal layer 3 is a positive type liquid crystal and the second liquid crystal layer 4 is a negative type liquid crystal. The positive type liquid crystal is generally called a rod-shaped liquid crystal with a characteristic of extraordinary light refractive index (ne)>ordinary light refractive index (no). The negative type liquid crystal is generally called a disk-shaped liquid crystal with a characteristic of ordinary light refractive index (nof)>extraordinary light refractive index (nef).

A general structure of the compensation member is that its second liquid crystal layer 4 is interposed between two transparent plastic substrates (not shown in the figure) resulting in a thin film shape. The compensation member is disposed between the liquid crystal panel and the first polarizer (or the second polarizer). In practice, the compensation member may be attached to the first polarizer first and then attach to the liquid crystal panel together. Alternatively, the compensation member may also be attached to the liquid crystal panel first and then the first polarizer is attached to the compensation member afterward.

The first liquid crystal layer 3 and the second liquid crystal layer 4 of the compensation member may be aligned by any known methods. In the present example, the top and bottom substrates of the first liquid crystal layer 3 of the liquid crystal panel and the second liquid crystal layer 4 of the compensation member are coated with polyimide alignment films (PI). A rubbing process by a cloth is performed to make the surface molecules of PI to arrange in a predetermined alignment orientation. This causes liquid crystal to possess an anchoring force in a single direction. Consequently, the first liquid crystal layer 3 and the second liquid crystal layer 4 have the first alignment direction and the second alignment direction, respectively.

In the present specification, “±0.2 degree of error” refers to the error value that may occur during alignment angle calculation. Possible errors include those caused by different people, different environmental conditions, and different instruments. In general, the range of errors for alignment angle calculation in the art is acceptable within ±0.2 degree, such as −0.2, −0.1, 0, +0.1, and +0.2 degree.

In the present example, the liquid crystal molecule 31 in the first liquid crystal layer 3 is a positive type liquid crystal and the liquid crystal molecule 41 in the second liquid crystal layer 4 is a negative type liquid crystal. A first inclined angle θ 1 (so called pre-tilt angle) is formed between a long axis 311 of the liquid crystal molecule 31 in the first liquid crystal layer 3 and a surface of the first polarizer 1. A second inclined angle θ 2 is formed between a short axis 411 of the liquid crystal molecule 41 in the second liquid crystal layer 4 and a surface of the first polarizer 1. (In FIGS. 1B and 1C, the surface of the first polarizer 1 is presented by a solid line 11). A difference between the first inclined angle and the second inclined angle may be −2 degree to 2 degree. Preferably, the first inclined angle and the second inclined angle are the same. In other words, the preferable relationship between the first inclined angle and the second inclined angle may be θ1−2<θ2<θ1+2 (deg). In addition, as the light passes through the first liquid crystal layer 3 with a total phase difference of (Δnd)_{cell} and as the light passes through the second liquid crystal layer 4 with a total phase difference of (Δnd)_{film}, it is preferable that (Δnd)_{cell}−100<(Δnd)_{film}<(Δnd)_{cell}+100 (nm) is satisfied.

In the liquid crystal display device of the present invention, the ordinary light refractive index and the extraordinary light refractive index of the first liquid crystal layer 3 and the second liquid crystal layer 4 are not limited. It is preferable that the ordinary light refractive index of the first liquid crystal layer 3 (no) and the extraordinary light refractive index of the second liquid crystal layer 4 (nef) are substantially the same. It is also preferable that the extraordinary light refractive index of the first liquid crystal layer 3 (ne) and the ordinary light refractive index of the second liquid crystal layer 4 (nof) are substantially the same.

In consideration for the thickness of the first liquid crystal layer of the liquid crystal panel and the thickness of the second liquid crystal layer of the compensation member, it is preferable that the first liquid crystal layer and the second liquid crystal layer satisfy the following equation:

(nof−nef)×df(ne−no)×d [Equation]

wherein nof is the ordinary light refractive index of the second liquid crystal layer, nef is the extraordinary light refractive index of the second liquid crystal layer, df is the thickness of the second liquid crystal layer, ne is the extraordinary light refractive index of the first liquid crystal layer, no is the ordinary light refractive index of the first liquid crystal layer, and d is the thickness of the first liquid crystal layer. The symbol “h” denotes that the values on each side of the equation are substantially the same. The term “substantially the same” includes error values within ±5, ±3, ±1 or ±0.5.

In addition, in the present invention, the thickness (df) of the second liquid crystal layer of the compensation member and the total phase difference associated with the refractive index difference are not limited as long as the condition satisfies (no−ne)×d−100<(nof−nef)×df<(no−ne)×d+100 (nm).

The configuration of the liquid crystal molecules 31 in the first liquid crystal layer 3 is not limited. It may be in-plane switching (IPS) type and fringe field switching (FFS) type. In the present example, the configuration of the first liquid crystal layer 3 is in-plane switching (IPS) type.

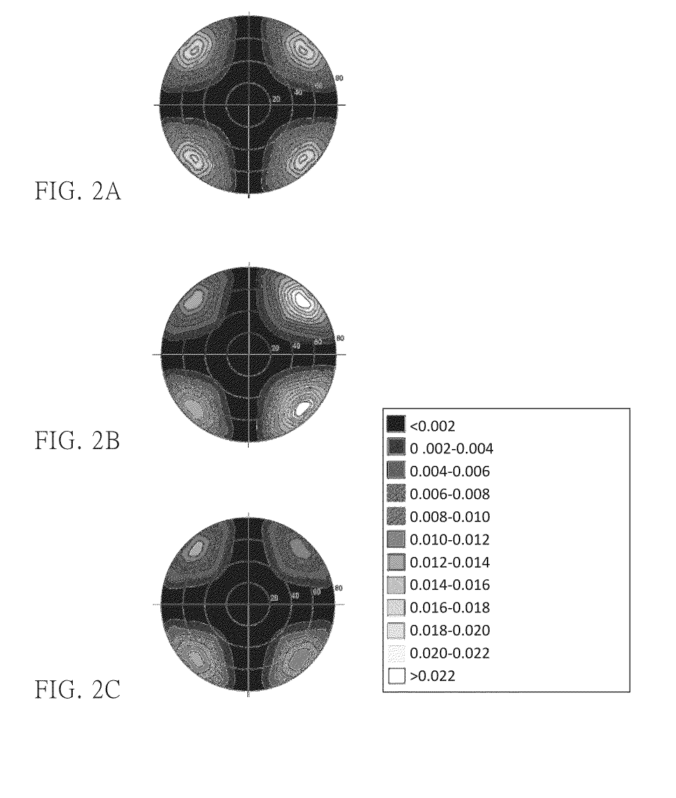

FIGS. 2A to 2C are the test results of the light leakage in the dark state of the liquid crystal display device. In particular, the extraordinary light refractory index (ne), the ordinary light refractive index (no), and the thickness (d) of the first liquid crystal layer 3 are ne=1.5876, no=1.4850, and d=3.10 μm, respectively. The tests are performed under the state that a light with a single wavelength of 550 nm is irradiated to a liquid crystal display device from the side of the first polarizer 1.

FIGS. 2A and 2B are control groups of the device in FIG. 1A without compensation members. FIG. 2A is a result for the simulation of the first liquid crystal layer 3 without a pre-tilt angle (θ1=0). FIG. 2B is a result for the simulation of the first liquid crystal layer 3 with a pre-tilt angle of 2 degree (θ1=2). FIG. 2C is a result of the experimental group of the device in FIG. 1A. The first inclined angle θ1 of the first liquid crystal layer 3 of the liquid crystal panel and the second inclined angle θ2 of the second liquid crystal layer 4 of the compensation member in the liquid crystal display device are both 2 degree (indicating that they have the same pre-tilt angle). The first liquid crystal layer 3 of the liquid crystal panel and the second liquid crystal layer 4 of the compensation member have substantially the same phase difference. The extraordinary light refractive index (nef), the ordinary light refractive index (nof), and the thickness (df) of the second liquid crystal layer 4 are nef=1.5430, nof=1.6035, and df=5.25 μm, respectively. Accordingly, in FIGS. 2A and 2B, when there is no compensation member disposed, the observation of an asymmetric state presented by the light leakage in the dark state is more obvious if a pre-tilt angle exists. In FIG. 2C, the visual angle asymmetry and the light leakage level in the dark state due to the existence of the pre-tilt angle may be effectively improved by disposing the compensation member.

### Example 2

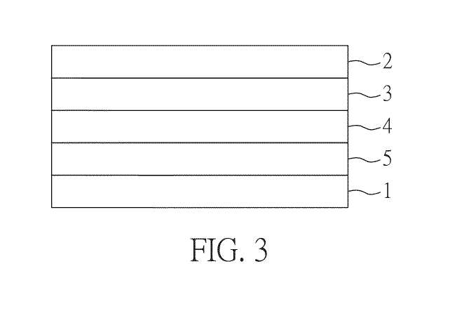

FIG. 3 is a schematic diagram of a liquid crystal display device according to another embodiment of the present invention. In addition to a commercial visual angle compensation film 5 (in the present example, NAZ270 compensation film is used) disposed between the first polarizer 1 and the compensation member 4, all the other elements are the same as that of the liquid crystal display device of FIG. 1A in Example 1. Thus, the description of the parts that are the same as Example 1 are omitted.

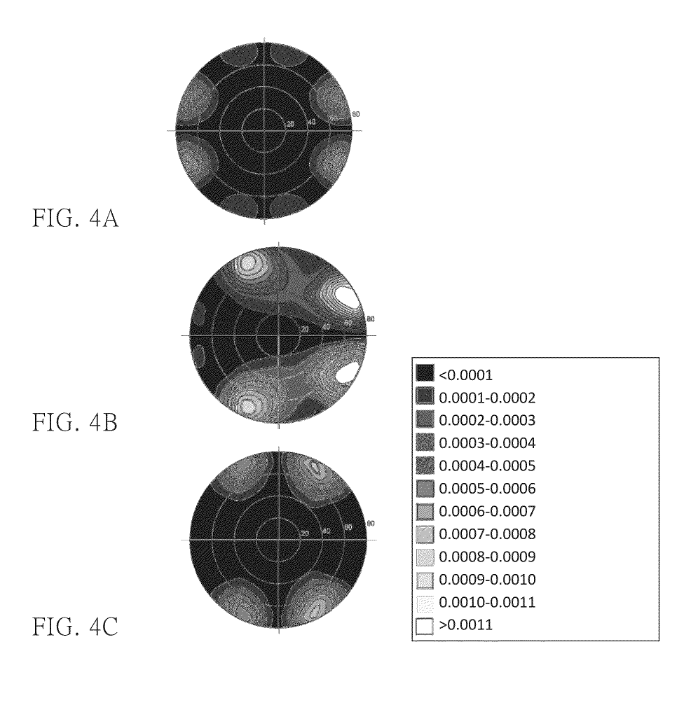

FIGS. 4A to 4C are the test results of the light leakage in the dark state of the liquid crystal display device. The tests are performed under the state that a light with a single wavelength of 550 nm is irradiated to a liquid crystal display device from the side of the first polarizer 1.

In FIG. 4A, the commercial visual angle compensation film 5 is disposed in the liquid crystal display device and the first liquid crystal layer 3 of the liquid crystal panel does not have a pre-tilt angle (θ1=0). In FIG. 4B, the commercial visual angle compensation film 5 is disposed in the liquid crystal display device and the first liquid crystal layer 3 of the liquid crystal panel has a pre-tilt angle of 2 degree (θ1=2). FIG. 4C is a result of the experimental group of the device in FIG. 3. In FIG. 4C, the commercial visual angle compensation film 5 as well as the compensation member with the second liquid crystal layer 4 are disposed in the liquid crystal display device. The first liquid crystal layer and the second liquid crystal layer both have a pre-tilt angle of 2 degree (θ1=2, θ2=2). In FIGS. 4A and 4B, the problems of asymmetry and light leakage may become much more serious due to the disposition of the commercial visual angle compensation film especially when a pre-tilt angle is presented. This is because the commercial visual angle compensation film is mainly used to compensate for the optical path difference of the side visual angle. It does not consider the visual angle leakage caused by the pre-tilt angle. It is obvious that the visual angle asymmetry and the light leakage level in the dark state of the present invention in Example 2 may be effectively improved after disposing the compensation member.

The commercial compensation film 5 may also be disposed between the first liquid crystal layer 3 and the second polarizer 2. In the case when the compensation member 4 is attached on the first liquid crystal layer 3 and disposed between the first liquid crystal layer 3 and the second polarizer 2, the commercial compensation film 5 may be disposed between the first liquid crystal layer 3 and the first polarizer 1 or between the compensation member 4 and the second polarizer 2. Accordingly, the relative positions of these elements may be adjusted by those skilled in the art based on different conditions.

### Example 3

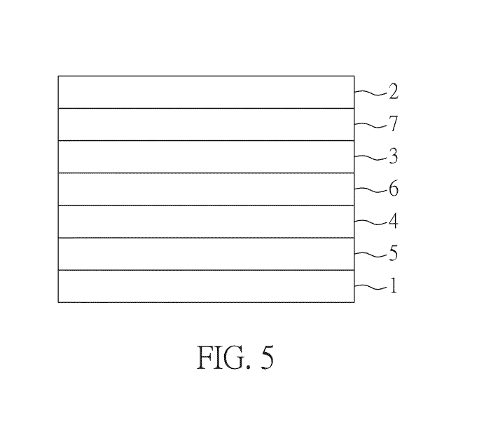

FIG. 5 is a schematic diagram of a liquid crystal display device according to another embodiment of the present invention. In the present example, the influences caused by an incident light with multi-wavelength and other films of the liquid crystal panel are further explored. The liquid crystal panel may further include a thin-film transistor (TFT) substrate 6 disposed between the first liquid crystal layer 3 and the compensation member 4 and a color filter substrate 7 disposed between the first liquid crystal layer 3 and the second polarizer 2. In addition to the above-mentioned elements, all the other elements are the same as that of the liquid crystal display device of FIG. 3 in Example 2. Thus, the descriptions of the parts that are the same as Example 2 are omitted.

In the present example, in FIG. 5, the detailed structure of the TFT substrate 6 is omitted including a gate, an insulated layer, a semiconductor layer, a source, and a drain. Also, the detailed structure of the color filter substrate 7 is omitted including a black matrix, a color layer, and an insulated layer. However, those skilled in the art can easily visualize the omitted structures of the TFT substrate and the color filter substrate. Other conventional structures may also be applied to the present invention.

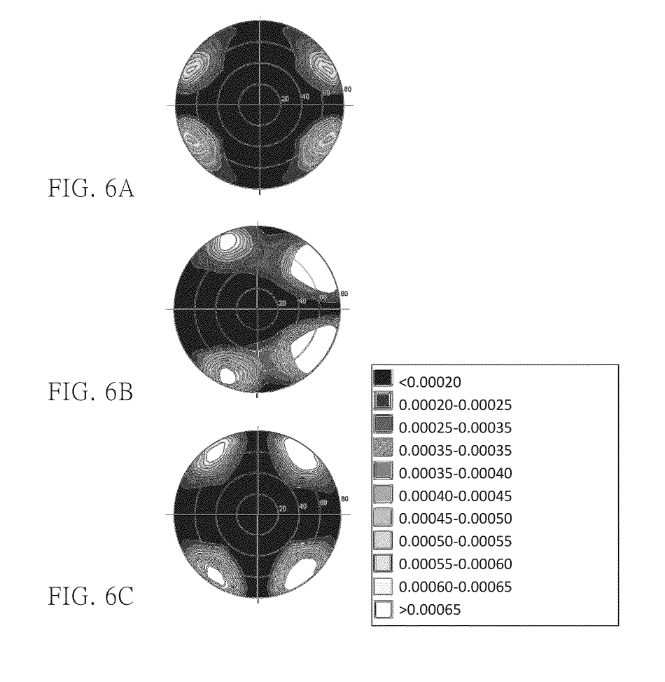

FIGS. 6A to 6C are the test results of the light leakage in the dark state of the liquid crystal display device. The test is performed under the state that the liquid crystal display device is irradiated by a LED back light unit (BLU) spectrum with multi-wavelengths from the side of the first polarizer 1. The simulation is performed with the liquid crystal panel having a structure including a TFT substrate, a liquid crystal layer, and a color filter substrate.

FIG. 6A is a control group simulating the result of the light leakage when the first liquid crystal layer of the liquid crystal panel does not have a pre-tilt angle (θ1=0) and when a commercial visual angle compensation film is disposed. FIG. 6B is the other control group simulating the result of the light leakage when the first liquid crystal layer of the liquid crystal panel has a pre-tilt angle of 2 degree (θ1=2) and when a commercial visual angle compensation film is disposed. FIG. 6C is a result of the experimental group of the device in FIG. 5. It simulates the result of the light leakage when the first liquid crystal layer of the liquid crystal panel has a pre-tilt angle of 2 degree (θ1=2) and a commercial visual angle compensation film and a compensation member with a second liquid crystal layer also having a pre-tilt angle of 2 degree (θ2=2) are disposed. Accordingly, the visual angle asymmetry and the light leakage level in the dark state may be significantly improved by disposing the compensation member. This improved effect is more pronounced especially in the low leakage area.

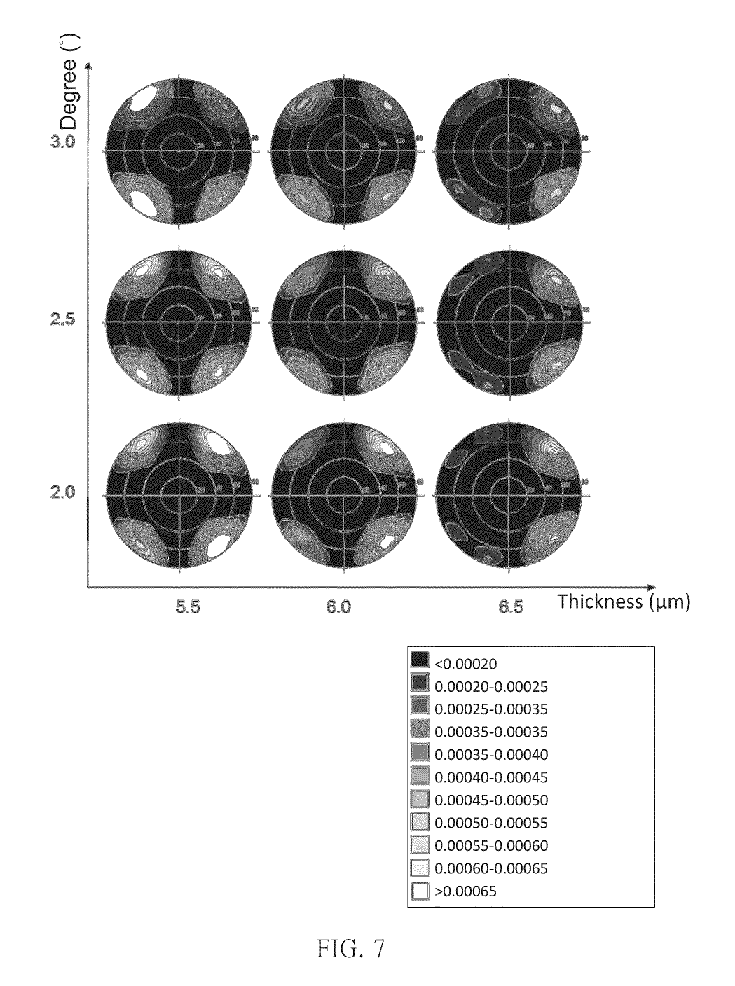

In order to obtain an even better effect, the pre-tilt angle (θ2) (also called the second inclined angle (θ2)) and the thickness (df) of the second liquid crystal layer of the liquid crystal display device in FIG. 5 are adjusted by the inventor. The result is shown in FIG. 7. When the second inclined angle (θ2) is about 3 degree and the thickness (df) is about 6 μm, the optimal symmetry of the visual angle and the lowest light leakage level may be obtained. Accordingly, it can be predicted that when the average light refractive index ((nef+nof)/2=1.57325) of the second liquid crystal layer of the compensation member is larger than the average light refractive index ((ne+no)/2=1.5363) of the first liquid crystal layer of the liquid crystal panel, the second inclined angle θ2 of the second liquid crystal layer needs to be larger than the first inclined angle θ1 of the first liquid crystal layer in order to obtain a better compensation effect.

In the present example, the compensation member 4 may be disposed between the color filter substrate 7 and the second polarizer 2. The compensation member 4 may also be disposed between the first polarizer 1 and the TFT substrate 6, between the color filter substrate 7 and the commercial compensation film 5, or between the commercial compensation film 5 and the second polarizer 2 if the commercial compensation film 5 is disposed between the color filter substrate 7 and the second polarizer 2. Accordingly, the relative positions of these elements may be adjusted by those skilled in the art based on different conditions.

Herein, the examples of the present invention have omitted all the other elements of the conventional liquid crystal display devices such as substrate and back light unit. Substrates such as glass substrate, plastic substrate, silicon substrate, and ceramic substrate and back light unit such as back board, light guide plate, and optical layer are omitted. Those skilled in the art may easily visualize the omitted elements of the liquid crystal display device. Conventional elements may be applied to the present invention.

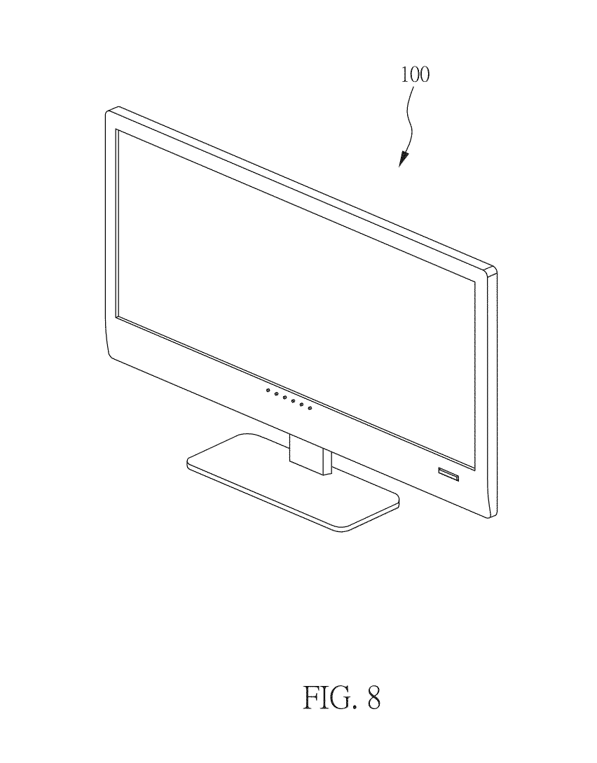

An example for the liquid crystal display device of the present invention is a liquid crystal display television 100 as shown in FIG. 8. The liquid crystal display devices in the above-mentioned examples of the present invention may also be the display devices for mobile phone, laptop, video camera, camera, music player, and GPS.

Although the present invention has been explained in relation to its preferred embodiments, it is to be understood that many other possible modifications and variations can be made without departing from the spirit and scope of the invention as hereinafter claimed.

What is claimed is:

1. A liquid crystal display device, comprising:
a first polarizer;
a second polarizer corresponding to the first polarizer;
a liquid crystal panel disposed between the first polarizer and the second polarizer, wherein the liquid crystal panel comprises a first liquid crystal layer having a first alignment direction; and
a compensation member disposed between the first polarizer and the liquid crystal panel, or between the second polarizer and the liquid crystal panel, wherein the compensation member is on the liquid crystal panel, and the compensation member comprises a second liquid crystal layer having a second alignment direction; wherein the first alignment direction is substantially the same with the second alignment direction, and the dielectric anisotropies of the first and the second liquid crystals are opposite to each other.

2. The liquid crystal display device as claimed in claim 1, wherein a first inclined angle is formed between the first polarizer and a long axis of a liquid crystal molecule in the first liquid crystal layer, a second inclined angle is formed between the first polarizer and a short axis of a liquid crystal molecule in the second liquid crystal layer, and the difference between the first inclined angle and the second inclined angle is from −2 degree to 2 degree.

3. The liquid crystal display device as claimed in claim 1, wherein the compensation member is disposed between the first polarizer and the liquid crystal panel.

4. The liquid crystal display device as claimed in claim 1, wherein the compensation member is disposed between the second polarizer and the liquid crystal panel.

5. The liquid crystal display device as claimed in claim 1, wherein the ordinary light refractive index of the first liquid crystal layer (no) is the same as the extraordinary light refractive index of the second liquid crystal layer (nef), and the extraordinary light refractive index of the first liquid crystal layer (ne) is the same as the ordinary light refractive index of the second liquid crystal layer (nof).

6. The liquid crystal display device as claimed in claim 1, wherein the first liquid crystal layer of the liquid crystal panel and the second liquid crystal layer of the compensation member satisfy the following equation:
(nof−nef)×df(ne−no)×d
(ne−no)×d−100<(nof−nef)×df<(ne−no)×d+100 [Equation]
wherein nof is the ordinary light refractive index of the second liquid crystal layer, nef is the extraordinary light refractive index of the second liquid crystal layer, df is a thickness of the second liquid crystal layer, ne is the extraordinary light refractive index of the first liquid crystal layer, no is the ordinary light refractive index of the first liquid crystal layer, and d is a thickness of the first liquid crystal layer.

7. The liquid crystal display device as claimed in claim 1, wherein the liquid crystal panel further comprises: a color filter substrate disposed between the second polarizer and the first liquid crystal layer, and the compensation member is disposed on the color filter substrate.

8. The liquid crystal display device as claimed in claim 1, wherein the liquid crystal panel further comprises: a color filter substrate disposed between the second polarizer and the first liquid crystal layer, and the compensation member is disposed between the first polarizer and the liquid crystal panel.

9. The liquid crystal display device as claimed in claim 8, wherein the liquid crystal panel further comprises: a thin-film transistor substrate disposed between the first polarizer and the first liquid crystal layer, and the compensation member is disposed on the thin-film transistor substrate.

10. The liquid crystal display device as claimed in claim 1, wherein the liquid crystal panel further comprises: a thin-film transistor substrate disposed between the first polarizer and the first liquid crystal layer, and the compensation member is disposed between the second polarizer and the liquid crystal panel.
